(19) United States
(12) Patent Application Publication
(10) Pub. No.: US 2007/0288125 A1
(43) Pub. Date: Dec. 13, 2007

(54) Power Over Ethernet (Poe) - Based Measurement System

(75) Inventor: Mark J. Quaratiello, Atkinson, NH (US)

Correspondence Address: MCDERMOTT WILL & EMERY LLP, 28 STATE STREET, BOSTON, MA, 02109-1775, US

(73) Assignee: MKS Instruments, Inc., Wilmington, MA (US)

(21) Appl. No.: 11/423,305

(22) Filed: Jun. 9, 2006

(51) Int. Cl. G08B 1/08

(52) U.S. Cl. 700/282; 340/538; 700/286

(57) ABSTRACT

Ethernet-enabled measurement systems are disclosed that are POE compatible. The measurement systems are configured to measure a physical variable, and to generate and communicate data representative of the measured physical variable. The physical variable may include, but is not limited to, fluid pressure, fluid flow rate, and fluid flow ratio. The POE compatible measurement systems are configured to communicate the data through a POE-capable cable over an Ethernet network in accordance with Ethernet networking protocol. The measurement systems are further configured to receive power through the same POE-capable cable from a power source connected to the Ethernet network.

### CROSS-REFERENCE TO RELATED APPLICATIONS

This application is related to U.S. application Ser. No. 10/178,884 filed Jun. 24, 2002 and issued as U.S. Pat. No. 6,810,308 on Oct. 26, 2004, entitled “Apparatus And Method For Mass Flow Controller With Network Access To Diagnostics” which is incorporated herein by reference in its entirety.

### BACKGROUND

A number of high-precision measurement systems may be useful in materials processing. These high-precision measurement systems may include, but are not limited to, mass flow controllers (MFCs), digital process manometers (DPMs), and flow ratio controllers (FRCs).

Ethernet-enabled measurement systems, for example Ethernet-enabled MFCs and Ethernet-enabled DPMs, have recently been developed. These Ethernet-enabled measurement systems allow the measured data to be communicated over networks such as Ethernet-based LANs (Local Area Networks) or the Internet, so that the data can be monitored and managed on-line from an Ethernet-enabled device connected to the Ethernet LAN or the Internet.

These Ethernet-enabled measurement systems currently need two independent cables: one cable for supplying power, and another cable for communicating data over the Ethernet. Typically, these systems may communicate data via wired data lines, for example a CAT 5 twisted pair cable, and receive power from a second cable that is connected to a power source, for example a DC or an AC outlet.

It is desirable to eliminate the need for the second cable. Using a single cable that carries both data and power would result in major cost savings as well as overall simplification. For example, cabling costs would be substantially reduced. It would no longer be necessary to provide separate power sources to operate these systems. An significant increase in cost effectiveness, convenience, and efficiency would result.

### SUMMARY

An apparatus includes a sensor configured to measure a physical variable, and to generate data representative of the measured physical variable. The apparatus further includes an Ethernet cable that is connectable to the sensor and that has POE capability. The cable is configured to both transmit the data from the sensor over an Ethernet network, and also to deliver power to the sensor from a power source connected to the Ethernet network.

An apparatus is configured to measure a physical variable and to generate data representative of the measured physical variable. The apparatus is further configured to communicate the data through a cable over an Ethernet network in accordance with Ethernet networking protocol. The apparatus is further configured to receive power through the same cable from a power source connected to the Ethernet network.

A method of generating data representative of measurements of a physical variable and communicating the data over the Ethernet includes measuring the physical variable and generating the data representing the measurements of the physical variable, using a sensor. The method further includes communicating the data over the Ethernet through an Ethernet cable. The method further includes delivering power to the sensor through the same Ethernet cable.

### BRIEF DESCRIPTION OF THE DRAWINGS

FIG. 1A illustrates an internal cable structure of an exemplary Ethernet cable.

FIG. 1B is a schematic diagram of an exemplary RJ45 jack connector and its plug pinout.

FIG. 1C shows a table of an exemplary cable pinout of a CAT5 straight-through cable.

FIG. 2 is a schematic block diagram illustrating an Ethernet-enabled measurement system that has power over Ethernet functionality, so as to both communicate the measured data through a cable over an Ethernet network, and also receive power through the same cable from a power source connected to the Ethernet network.

FIG. 3 illustrates delivery of power to a POE-compatible measurement system using a POE-capable Ethernet cable in which the two spare or normally unused pairs are used to deliver power.

### DETAILED DESCRIPTION

In the present disclosure, Ethernet-enabled measurement systems are described that are POE compatible, i.e. that are configured to receive power based on power over Ethernet (POE) technology. POE technology allows these Ethernet-enabled measurement systems to receive power as well as data over existing network cabling, without need to modify existing Ethernet infrastructure. Only a single Ethernet cable, instead of separate power and data cables, needs to be run to these POE-compatible measurement systems.

Ethernet-enabled measurement systems are described, for example, U.S. Pat. No. 6,810,308, entitled “Apparatus And Method For Mass Flow Controller With Network Access To Diagnostics”, which is incorporated by reference in its entirety. These measurement systems are configured to measure physical variables, for example fluid pressure, fluid flow rate, and fluid flow ratio.

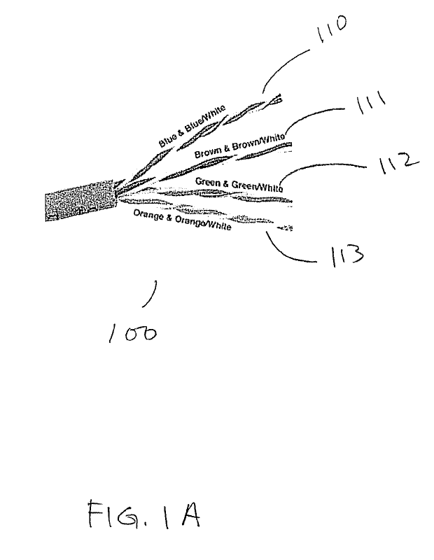

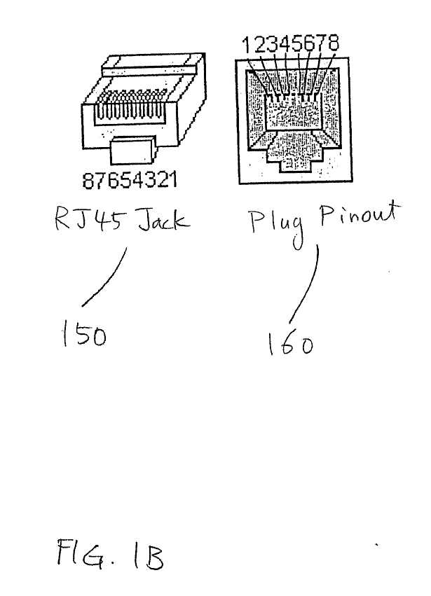

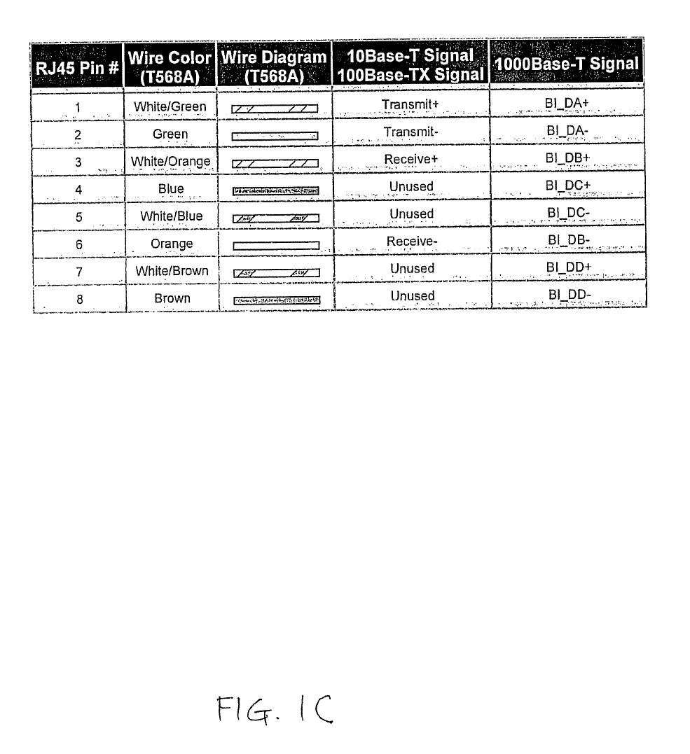

Currently, these Ethernet-enabled measurement systems use two independent cables to transmit data and power, respectively. To transmit data over the Ethernet to and from these measurement systems, an RJ45 (Registered Jack 45) connector is typically used in combination with four pairs of twisted pair wires. When separate cables are used for data and power transfer, four pins out of an 8-pin RJ45 connector, as well as two of the four pairs of twisted pair wires, are idle. This is because only two pairs of the twisted pair wires are occupied while transmitting data, as illustrated in FIGS. 1A, 1B, and 1C below.

FIG. 1A illustrates an internal cable structure of an exemplary Ethernet cable. For illustrative purposes, a CAT5 (Category 5) UTP (Unshielded Twisted Pair) cable 100 is illustrated that provides basic 10/100 BaseT functionality. Other types of Ethernet cables are also available, including but not limited to CAT3 cables, CAT5e cables (for gigabit operations) and CAT6 cables. Any one of available Ethernet cables may be configured to provide POE functionality to the Ethernet-enabled measurement systems described in this disclosure.

As seen in FIG. 1A, there are eight wires inside the CAT5 cable 100. These wires are twisted into 4 pairs of wires, indicated in FIG. 1A using reference numerals 110, 111, 112, and 113, respectively. The twisted configuration of the wires may counter-act noise and interference. Typically, these eight wires may be color-coded, and each pair may have a common color theme. For example, the color coding for the four pairs of wires may be blue & blue/white, brown & brown/white, green & green/while, and orange & orange/white, respectively. A number of different wiring standards may be used for the cable 100, including T568A and T568B, just to name a few. Depending on the wiring scheme, the Ethernet cable may be a straight through cable or a cross-over cable.

The four pairs of twisted pair wires are typically used in combination with an RJ45 jack connector. FIG. 1B provides a diagram of an exemplary RJ45 jack connector 150 and the plug pinout 160 for the RJ45 jack connector. As seen from FIG. 1B, the RJ45 jack connector 150 may be an eight-position modular connector, shaped like a phone plug. Some RF45 jack connectors may be configured to receive braided wires, while other RF45 jack connectors may be configured to receive solid wires.

The IEEE specification for Ethernet 10BaseT requires that two of the four twisted pairs be used, one pair connected to pins 1 and 2 of the RJ45 jack connector 150, the second pair connected to pins 3 and 6 of the RJ45 jack connector 150. FIG. 1C provides a table of an exemplary cable pinout of a CAT5 straight-through cable wired according to the T568A standard. As seen from the table, in conventional CAT5 Ethernet cables, only four of the eight twisted pair wires, namely those wires configured to be connected to pin #s 1, 2, 3, and 6, respectively, are used to transmit or receive data. The remaining four twisted pair wires, namely those wires configured to be connected to pin #s 4, 5, 7, and 8, remain unused and idle.

A technology called Power over Ethernet (POE) has been developed which utilizes the idle unused pins to transmit power. POE technology allows Ethernet-enabled devices to receive power as well as data over existing LAN cabling. POE eliminates the need to run DC or AC power to Ethernet-enabled devices on a wired LAN. With POE, only a single Ethernet cable (e.g. a CAT5 cable) that carries both power and data to each Ethernet-enabled device is needed. Devices such as VoIP (Voice over Internet Protocol) telephones and web cameras, to name a few, may now be configured to receive power using POE technology.

In POE, the idea is to supply both the power and the Ethernet data connectivity requirements to these measurement systems via a single Ethernet cable. This is accomplished by inserting DC voltage into the used wires (the pairs of wires that are connected to pins 7-8 and pins 4-5 of the RJ45 jack connector, respectively) in a standard Ethernet cable as illustrated and described above. In some modes of operation, POE may also allow the data-carrying pairs of wires (connected to pins 1-2 and 3-6, respectively) to also supply power.

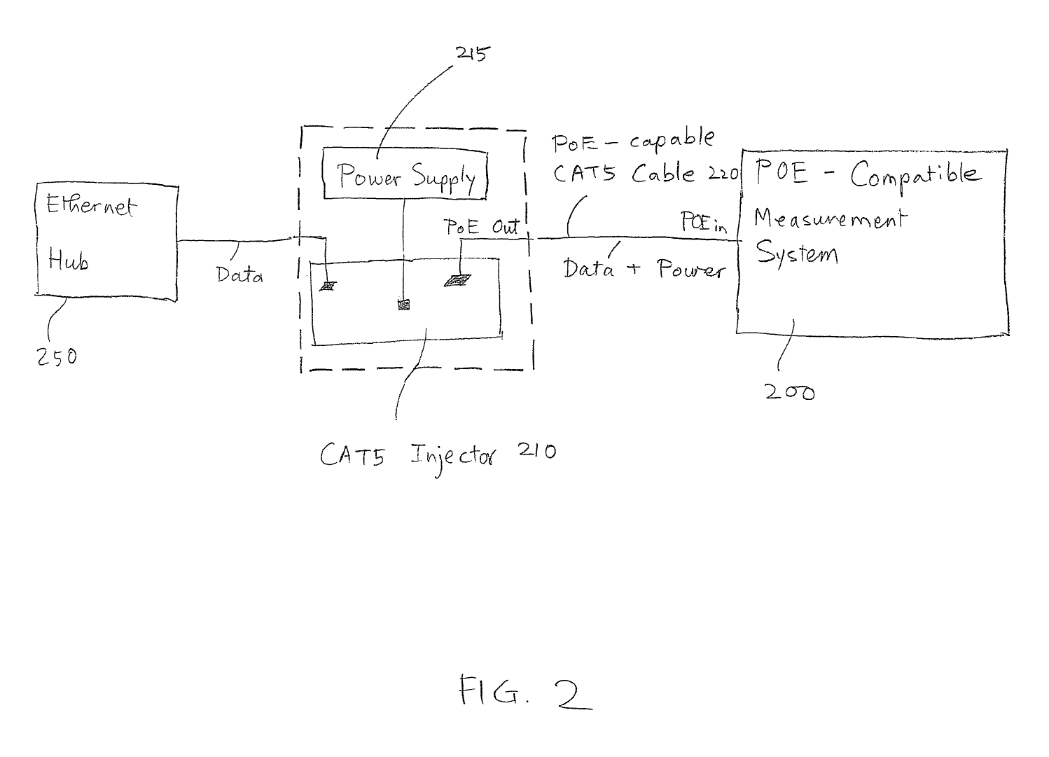

FIG. 2 is a schematic block diagram illustrating delivery of power to an Ethernet-enabled measurement system 200 that is POE-compatible, in one embodiment of the present disclosure. The Ethernet-enabled measurement system 200 comprises a communications processor 210 configured to process the data so that the data can be communicated through the Ethernet cable over the Ethernet network in accordance with Ethernet networking protocol.

The Ethernet-enabled measurement system 200 is configured to both communicate the measured data through the POE-capable Ethernet cable 220, and also to receive power through the same cable 220. In particular, the Ethernet-enabled measurement system 200 is configured to accept the injected DC power directly from the POE-capable Ethernet cable 220, through their RJ45 jack connector.

Typically, a power injector such as the CAT5 injector 210 illustrated in FIG. 2 may be used to insert a DC voltage (generated by a power supply 215) onto a POE-capable Ethernet cable 220. The CAT5 injector 210 may typically be installed near an Ethernet switch or hub 250.

The POE compatible measurement system 200 may be any one of a number of different types of Ethernet-enabled measurement systems. Many different measurement systems may be configured to be POE compatible in the manner described above. For example, an Ethernet-enabled manometer, described in the MKS-177 application, may be configured to be POE compatible. The Ethernet-enabled manometer may include a pressure sensor configured to measure pressure, and a controller configured to process the pressure data generated by the sensor so that the data can be communicated over an Ethernet network. The pressure sensor may be a capacitance pressure transducer having a deflectable diaphragm, and a capacitance detecting circuit. The capacitance detecting circuit may be configured to detect a change in capacitance caused by a deflection of the diaphragm in response to a pressure applied thereto, where the change in capacitance is a known function of the applied pressure.

As another example, an Ethernet-enabled MFC (mass flow controller), described in the '608 application and including a mass flow sensor configured to measure mass flow rate of a fluid, may be configured to be POE compatible. As another example, an Ethernet-enabled FRC (flow ratio controller) may be configured to be POE compatible. The FRC may be configured to measure and control the flow ratio between a plurality of fluid flow rates.

As a further example, an Ethernet-enabled MFV (mass flow verifier) may be configured to be POE compatible. The MFV may be configured to measure a mass flow rate, and to verify the measured mass flow rate. As yet another example, an Ethernet-enabled pressure controller (PC) may be configured to measure a pressure, and may include a controller configured to regulate the pressure to a desired value

An IEEE standard has been developed that addresses PoE issues, namely IEEE802.3 af, which defines the specification for Ethernet power sourcing equipment and powered terminals. The IEEE802.3af standard specs the voltage on the cable, the current on the cable, and the power on the POE receiving device, among other things. This specification standardized on the use of 48 volts of direct current as the injected POE voltage, over unshielded twisted-pair cable. It may works with existing category 3, 5, 5e or 6 cable, as well as standard connecting hardware, without requiring modification. A detection mechanism within the power sourcing equipment may authenticate POE-compliant devices.

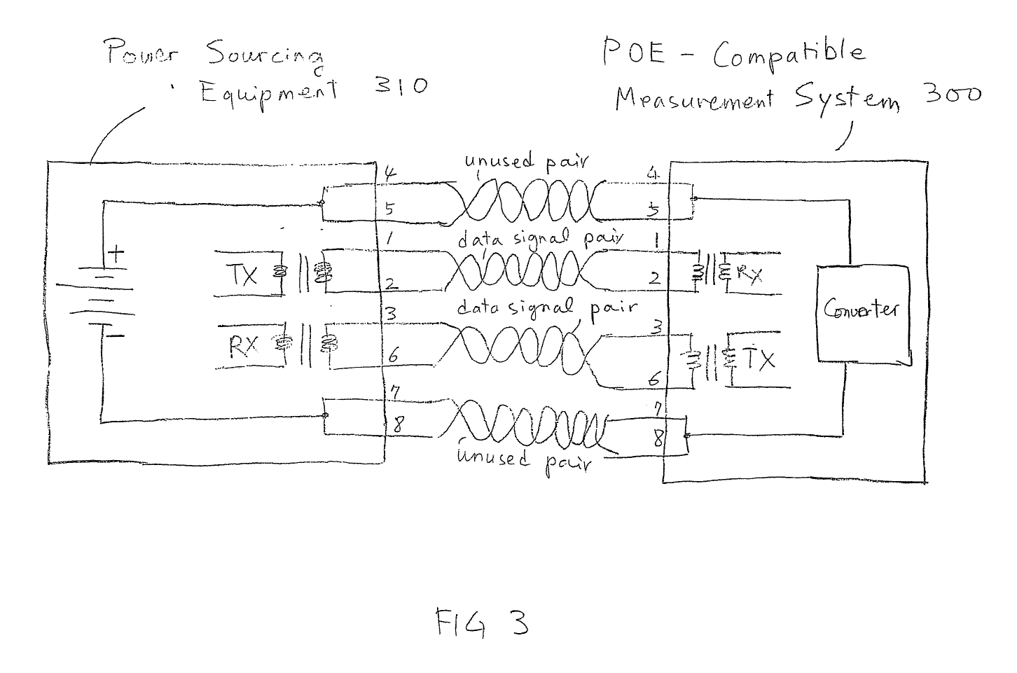

In one embodiment of the present disclosure, illustrated in FIG. 3, power may be delivered to a POE-compatible measurement system 300 through a POE-capable Ethernet cable in which the two spare or normally unused pairs (connected to pins 4, 5, 7, 8 of the RJ45 jack connector) are used to deliver power. As illustrated in FIG. 3, in this embodiment the pair of wires on pin 4 and pin 5 may be connected together and form the positive supply in a power sourcing equipment 310, while the pair of wires pins 7 and 8 may be connected together and form the negative supply in the power sourcing equipment 310. The IEEE802.3af standard allows either polarity to be used, so the polarities may be reversed, as compared to the configuration illustrated in FIG. 3.

The IEEE802.3af standard does not require that only the spare unused pairs of wires be used to deliver power. Power may also be delivered to the Ethernet-enabled measurement system 200 through a POE-capable Ethernet cable using the same two pairs that were also used to carry data, and that were connected to 1,2 3, 6 of the RJ45 jack connector, respectively. Unused and data carrying pairs may not both be used to deliver power, however.

Although the IEEE defined the IEEE802.3af POE standard, different equipment vendors may use different POE voltages. The measurement systems described in this disclosure may be configured to receive power using POE technology that may or may not conform to IEEE802.3af.

In sum, Ethernet-enabled measurement systems have been described that are configured to be POE compatible. By using POE, cabling costs can be significantly reduced, since a single cable provides both power and data. Overall reliability may be increased, since a UPS (uninterruptible power supply) at the power distribution source can guarantee power to all connected devices. POE may also allow monitoring and controlling of network-connected measurement systems, for example resetting them and/or shutting them down remotely. Using POE, power could be recycled to a unit via the Ethernet trouble shooting, if the unit is on a POE capable network.

While certain embodiments of a POE-based Ethernet-enabled measurement system have been described, it is to be understood that the concepts implicit in these embodiments may be used in other embodiments as well. The protection of this application is limited solely to the claims that now follow. In these claims, reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus comprising:
a sensor configured to measure a physical variable, and to generate data representative of the measured physical variable; and
an Ethernet cable connectable to the sensor, the Ethernet cable having POE (power over Ethernet) capability so as to both transmit the data from the sensor over an Ethernet network and also deliver power to the sensor from a power source connected to the Ethernet network.

2. The apparatus of claim 1, further comprising a communications processor configured to process the data so that the data can be communicated through the Ethernet cable over the Ethernet network in accordance with Ethernet networking protocol.

3. The apparatus of claim 1, wherein the cable is configured to deliver power to the sensor in accordance with the IEEE802.3af standard.

4. The apparatus of claim 1, wherein the Ethernet cable comprises at least one of:
a CAT3 cable;
a CAT5 cable;
a CAT5e cable; and
a CAT6 cable.

5. The apparatus of claim 1,
wherein the Ethernet cable comprises a plurality N of twisted pair wires and an RJ45 jack connector containing a corresponding plurality N of pins i (i=1, . . . N);
wherein each of the N twisted pair wires is couplable to a corresponding one of the N pins i of the RJ45 jack connector; and
wherein each of the N twisted pair wires is configured to carry at least one of:
data from the sensor; and
power from the power source.

6. The apparatus of claim 5,
wherein N=8, and the plurality N of wires comprise four pairs of twisted pair wires;
wherein two out of the four pairs of twisted pair wires are configured to carry data from the sensor over the Ethernet, and the remaining two out of the four pairs are configured to deliver power from the power source to the sensor over the Ethernet.

7. The apparatus of claim 5,
wherein the two pairs of twisted pair wires that are configured to carry data from the sensor are couplable to pins 1, 2, 3, and 6 of the RJ45 jack connector; and
wherein the two pairs of twisted pair wired that are configured to carry power from the power source are couplable to pins 4,5, 7, and 8 of the RJ45 jack connector.

8. The apparatus of claim 5,
wherein the two pairs of twisted pair wires that are configured to carry data from the sensor are couplable to pins 1, 2, 3, and 6 of the RJ45 jack connector; and
wherein the two pairs of twisted pair wired that are configured to carry power from the power source are also couplable to pins 1,2, 3, and 6 of the RJ45 jack connector.

9. The apparatus of claim 1 comprising a manometer, wherein the physical variable comprises pressure, and the sensor comprises a pressure sensor.

10. The apparatus of claim 9,
wherein the pressure sensor comprises a capacitance pressure transducer, and
wherein the capacitance pressure transducer comprises:
a deflectable diaphragm; and
a capacitance detecting circuit configured to detect a change in capacitance caused by a deflection of the diaphragm in response to a pressure applied thereto, the change in capacitance being a known function of the applied pressure.

11. The apparatus of claim 1 comprising a mass flow controller (MFC),
wherein the physical variable comprises a mass flow rate of a fluid, and the sensor comprises a mass flow sensor; and
further comprising a controller configured to regulate the mass flow rate to a desired value.

12. The apparatus of claim 1 comprising a flow ratio controller (FRC),
wherein the physical variable comprises a ratio between two or more fluid flow rates;
wherein the sensor comprises a mass flow sensor configured to measure the two or more fluid flow rates and a flow ratio calculator configured to calculate the ratio between the measured fluid flow rates; and
further comprising a controller configured to control the ratio between the fluid flow rates to a desired value.

13. An apparatus for measuring a physical variable and for generating data representative of the measured physical variable,
wherein the apparatus is configured to communicate the data through a cable over an Ethernet network in accordance with Ethernet networking protocol, and
wherein the apparatus is further configured to receive power through the same cable from a power source connected to the Ethernet network.

14. The apparatus of claim 13, wherein the apparatus is POE compatible, and wherein the cable is a POE-capable cable that is able to both transmit the data over an Ethernet network, and also deliver power to the sensor from a power source connected to the Ethernet network.

15. The apparatus of claim 13, wherein the apparatus comprises at least one of:
an Ethernet-enabled digital process manometer (DPM) configured to measure a pressure;
an Ethernet-enabled mass flow controller (MFC) configured to measure a flow rate of a fluid, and including a controller configured to regulate the flow rate to a desired value;
an Ethernet-enabled mass flow verifier (MFV) configured to measure and verify a mass flow rate;
an Ethernet-enabled pressure controller (PC) configured to measure a pressure, and including a controller configured to regulate the pressure to a desired value; and
an Ethernet-enabled flow ratio controller (FRC) configured to measure two or more fluid flow rates, and including a controller for controlling the ratios between the fluid flow rates.

16. A method of generating data representative of measurements of a physical variable and communicating the data over the Ethernet, the method comprising:
measuring the physical variable and generating the data representing the measurements of the physical variable, using a sensor;
communicating the data over the Ethernet through an Ethernet cable; and
delivering power to the sensor through the same Ethernet cable.

17. The method of claim 16,
wherein the physical variable comprises at least one of: a fluid pressure, a fluid flow rate, and a flow ratio between a plurality of fluid flow rates; and
wherein the sensor comprises at least one of: a pressure sensor and a mass flow sensor.

18. The method of claim 17, wherein the Ethernet cable comprises at least one of a CAT3 cable, a CAT5 cable, a CAT5e cable, and a CAT6 cable, and wherein each of these cables is configured to provide power over Ethernet functionality.

19. The method of claim 16, wherein the act of delivering power to the sensor through the same Ethernet cable comprises delivering power to the sensor in accordance with the IEEE802.3af standard.
